(19) United States
(12) Patent Application Publication
(10) Pub. No.: US 2009/0028041 A1
(43) Pub. Date: Jan. 29, 2009

(54) Information Recording Medium, Information Recording Apparatus and Information Recording Method, and Computer Program

(75) Inventor: Kazuo Kuroda, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 11/918,169

(22) PCT Filed: Apr. 13, 2006
(86) PCT No.: PCT/JP2006/307825

§ 371 Date: Oct. 10, 2007

(30) Foreign Application Priority Data
Apr. 13, 2005 (JP) 2005-115516

(51) Int. Cl. G11B 7/00

(52) U.S. Cl. 369/275.4

(57) ABSTRACT

An information recording medium (100) is provided with: a recording track (GT), which is wobbled, on which information is recorded by forming a recording pit row thereon, the recording pit row is formed to be wobbled in an opposite phase to a phase of the wobbling of the recording track.

### TECHNICAL FIELD

The present invention relates to an information recording medium, such as a DVD, an information recording apparatus and an information method, such as a DVD recorder, and a computer program which makes a computer function as such an information recording apparatus.

### BACKGROUND ART

For example, on an information recording medium, such as a read-only type optical disc, like a CD-ROM (Compact Disc-Read Only Memory), a DVD-ROM, or the like, various information is recorded by forming depressions (or holes), which are referred to as recording pits, on a recording layer.

On the other hand, on an information recording medium, such as a recording type optical disc, like a CD-R/RW, a DVD-R/RW, or the like, various information is recorded by irradiating the recording layer with laser light for recording, to change the state of the recording layer. More specifically, in the case of an optical disc, such as a DVD-R, provided with the recording layer which is formed of e.g. an organic dye film, the organic dye film is damaged by heat which is generated by the irradiation of the laser light, and as a result, the state in the portion that is irradiated with the laser light is changed. Alternatively, in the case of an optical disc, such as a DVD-RW, provided with the recording layer which is formed of e.g. a phase change film, the state of the phase change film is changed by heat which is generated by the irradiation of the laser light, from a crystalline state to a noncrystalline state (or an amorphous state), or from the noncrystalline state to the crystalline state. The change in the state causes the recording pits (or record marks in this case) to be formed, wherein the recording pits have the same features as those of the depressions in the read-only type optical disc. At this time, on the recording type optical disc, the recording pits are formed in appropriate positions, with reference to a recording track, which is referred to as a groove track or a land track.

### DISCLOSURE OF INVENTION

### Subject to be Solved by the Invention

As described above, the recording type optical disc has the groove track or land track, which is not provided for the read-only type optical disc. Thus, even if the same information is recorded onto the read-only type optical disc and the recording type optical disc, a reproduction waveform which is obtained by the reproduction of the read-only type optical disc is significantly different from a reproduction waveform which is obtained by the reproduction of the recording type optical disc. Thus, this can influence the reproduction compatibility between the optical discs of two types. In the worst case, the compatibility cannot be maintained, and there is such a technical problem that the information recorded on the recording type optical disc cannot be reproduced on a reproducing apparatus which performs the reproduction of the read-only type optical disc.

In view of the aforementioned conventional problems, it is therefore an object of the present invention to provide an information recording medium, which can provide good compatibility with a read-only type information recording medium, as well as an information recording apparatus and an information recording method, and a computer program.

### Means for Solving the Subject

(Information Recording Medium)

The above object of the present invention can be achieved by an information recording medium provided with: a recording track, which is wobbled, on which information is recorded by forming a recording pit row thereon, the recording pit row being formed to be wobbled in an opposite phase to a phase of the wobbling of the recording track.

According to the information recording medium of the present invention, video information, audio information, and other various information are recorded by forming the recording pit row, which includes many recording pits (i.e. the recording pit row corresponding to the arrangement of the recording pits), on the recording track. The recording track is wobbled in a predetermined cycle. At this time, the entire recording track may be wobbled in the predetermined cycle. Alternatively, one portion of the recording track may be wobbled in one cycle, and another portion of the recording track may be wobbled in another cycle. The wobbling of the recording track is referred to, when timing of recording the information is looked for or when a recording operation is controlled.

In particular, in the present invention, the phase of the wobbling of the recording track is opposite to that of the wobbling of the recording pit row which is formed on the recording track. Specifically, if a direction in which the information is recorded (i.e. a traveling direction of the recording track) is set as a reference axis, the wobbling direction (or swing direction) of the recording track and the wobbling direction of the recording pit row are opposite to each other. That is, if the recording tack swings relatively to the right side along the direction that the information is recorded, the recording pit row swings relatively to the left side. On the other hand, if the recording tack swings relatively to the left side along the direction that the information is recorded, the recording pit row swings relatively to the right side. In other words, the recording pit row is formed that is wobbled in an opposite pattern to a pattern of the wobbling of the recording track.

Thus, if the recording pit row is reproduced, a push-pull signal is obtained from each of the recording track and the recording pit row. At this time, since the phase of the wobbling of the recording track and the phase of the wobbling of the recording pit row are opposite to each other, a signal component caused by the recording track and a signal component caused by the recording pit row are opposite to each other. For example, in the case where the signal component caused by the recording track has a maximum peak value, the signal component caused by the recording pit row has a minimum peak value. Thus, a sum of the both signal components (i.e. the push-pull signal which is actually obtained in a reproduction operation) can be regarded as a direct current signal. On the other hand, in the case of a read-only type information recording medium, there is no recording track of the present invention, so that the signal component caused by the recording pit row (i.e. the push-pull signal) is obviously equivalent to the direct current signal.

That is, according to the information recording medium of the present invention, it is possible to obtain a reproduction signal which is the same or substantially the same as the reproduction signal that is obtained from the read-only type information recording medium. Thus, even in the case of an information reproducing apparatus for the reproduction of the read-only type information recording medium, it is possible to preferably reproduce the recording pit row recorded on the information recording medium of the present invention, without any special problem. That is, according to the information recording medium of the present invention, even the recording type information recording medium can be preferably compatible with the read-only type information recording medium.

Incidentally, the expression that “opposite . . . to a phase of the wobbling” does not necessarily mean exactly opposite in a strict sense, and there may be a slight shift as long as it does not influence the compatibility with the read-only type information recording medium.

In one aspect of the information recording medium of the present invention, an amplitude of the wobbling of the recording pit row is substantially twice as large as an amplitude of the wobbling of the recording track.

The recording pit row may be formed by combining a mark portion in which the state of the recording layer is generally changed (or the state is one state) and a space portion in which the state of the recording layer is not changed (or the state is changed to another state which is different from the one state). Therefore, according to this aspect, it is possible to substantially equalize the amplitude of the signal component caused by the recording track and the amplitude of the signal component caused by the recording pit row, in view of the combination of the mark portion and the space portion. Therefore, it is possible to more preferably provide the compatibility between the recording type information recording medium and the read-only type information recording medium.

In another aspect of the information recording medium of the present invention, a duty ratio of the recording pit row is about 50%. In other words, in the entire recording pit row, a ratio occupied by the mark portion and a ratio occupied by the space portion are substantially the same.

According to this aspect, it is possible to substantially equalize the amplitude of the signal component caused by the recording track and the amplitude of the signal component caused by the recording pit row, in view of the combination of the mark portion and the space portion. Therefore, it is possible to more preferably provide the compatibility between the recording type information recording medium and the read-only type information recording medium.

In another aspect of the information recording medium of the present invention, the recording track is modulated and wobbled.

According to this aspect, even in the information recording medium on which BPM (Bi Phase Modulation) modulation is performed on the recording track, such as a DVD+R/RW, it is possible to receive the aforementioned various benefits.

(Information Recording Apparatus)

The above object of the present invention can be also achieved by an information recording apparatus provided with: a recording device for recording information by forming a recording pit row on a recording track which is wobbled; and a controlling device for controlling the recording device to form the recording pit row which is wobbled in an opposite phase to a phase of the wobbling of the recording track.

According to the information recording apparatus of the present invention, the recording pit row is formed on the recording track which is wobbled in the predetermined cycle, by the operation of the recording device. By this, the information is recorded onto the information recording medium.

In particular, in the present invention, the recording device is controlled by the operation of the controlling device so as to form the recording pit row which is wobbled in the opposite phase to a phase of the wobbling of the recording track. Therefore, from the information recording medium on which such a recording pit row is formed, it is possible to obtain a reproduction signal which is the same or substantially the same as the reproduction signal that is obtained from the read-only type information recording medium, as described above. Thus, even in the case of an information reproducing apparatus for the reproduction of the read-only type information recording medium, it is possible to preferably reproduce the recording pit row recorded on the information recording medium of the present invention, without any special problem. That is, according to the information recording apparatus of the present invention, the information can be recorded onto the recording type information recording medium such that the recording type information recording medium can be preferably compatible with the read-only type information recording medium.

In one aspect of the information recording apparatus of the present invention, the controlling device controls the recording device to form the recording pit row whose amplitude of the wobbling is substantially twice as large as an amplitude of the wobbling of the recording track.

According to this aspect, it is possible to substantially equalize the amplitude of the signal component caused by the recording track and the amplitude of the signal component caused by the recording pit row, in view of the combination of the mark portion and the space portion. Therefore, it is possible to more preferably provide the compatibility between the recording type information recording medium and the read-only type information recording medium.

In another aspect of the information recording apparatus of the present invention, the controlling device controls the recording device to form the recording pit whose duty ratio is about 50%. In other words, the recording device is controlled so as to form the recording pit row in which a ratio occupied by the mark portion and a ratio occupied by the space portion are substantially the same.

According to this aspect, it is possible to substantially equalize the amplitude of the signal component caused by the recording track and the amplitude of the signal component caused by the recording pit row, in view of the combination of the mark portion and the space portion. Therefore, it is possible to more preferably provide the compatibility between the recording type information recording medium and the read-only type information recording medium.

In another aspect of the information recording apparatus of the present invention, the recording track is modulated and wobbled.

According to this aspect, even in the information recording medium on which BPM (Bi Phase Modulation) modulation is performed on the recording track, such as a DVD+R/RW, it is possible to receive the aforementioned various benefits.

In another aspect of the information recording apparatus of the present invention, it is further provided with a speed reducing device for reducing a recording speed of the information, compared to a case where the recording pit row which is wobbled in the same phase as the phase of the wobbling of the recording track is formed.

According to this aspect, it is possible to form the recording pit row while relatively reducing the recording speed. Therefore, it is possible to form the recording pit row, which is wobbled in the opposite phase to the phase of the wobbling of the recording track, relatively easily and preferably.

In another aspect of the information recording apparatus of the present invention, it is further provided with: a detecting device for detecting at least one of the phase and an amplitude of the wobbling of the recording track; a delay giving device for giving a phase delay to a record signal in order to form the recording pit row, on the basis of the detected phase of the wobbling; and a gain adjusting device for adjusting gain of the record signal on the basis of the detected amplitude of the wobbling.

According to this aspect, the recording pit row is formed on the basis of the phase and amplitude of the wobbling of the recording track, which are detected by the operation of the detecting device. Specifically, the phase delay based on the phase of the wobbling of the recording track is given to the record signal, by the operation of the delay giving device. That is, the phase delay is given to the record signal so as to form the recording pit row which is wobbled in the opposite phase to the phase of the wobbling of the recording track. Moreover, the gain of the record signal is adjusted on the basis of the amplitude of the wobbling of the recording track, by the operation of the gain adjusting device. That is, the gain of the record signal is adjusted so as to form the recording pit row which is wobbled with an amplitude which is substantially twice as large as the amplitude of the wobbling of the recording track. By this, it is possible to form the recording pit row which is wobbled in the opposite phase to that of the wobbling of the recording track.

In another aspect of the information recording apparatus of the present invention, the recording device includes: an irradiating device for irradiating laser light to thereby form the recording pit row; and an optical path adjusting device for adjusting an optical path of the laser light.

According to this aspect, by adjusting the optical path of the laser light by the operation of the optical path adjusting device, it is possible to form the recording pit row which is wobbled in the opposite phase to that of the wobbling of the recording track, relatively easily.

In an aspect of the information recording apparatus provided with the optical path adjusting device, as described above, the optical path adjusting device may be provided with a piezo element.

By virtue of such construction, it is possible to adjust the optical path of the laser light by using the piezo element which can respond at high speed. Therefore, regardless of how the recording track is wobbled, it is possible to preferably form the recording pit row which wobbles in the opposite phase to that of the wobbling.

(Information Recording Method)

The above object of the present invention can be also achieved by an information recording method on an information recording apparatus provided with: a recording device for recording information by forming a recording pit row on a recording track which is wobbled, the information recording method provided with: a first controlling process of controlling the recording device to form the recording pit row corresponding to the information; and a second controlling process of controlling the recording device to form the recording pit row which is wobbled in an opposite phase to a phase of the wobbling of the recording track.

According to the information recording method of the present invention, it is possible to receive the same various benefits as those of the information recording apparatus of the present invention described above.

Incidentally, in response to various aspects of the information recording apparatus of the present invention described above, the information recording method of the present invention can also employ various aspects.

(Computer Program)

The above object of the present invention can be also achieved by a computer program for recording control to control a computer provided in the aforementioned information recording apparatus of the present invention (including its various aspects), the computer program making the computer function as the controlling device.

According to the computer program of the present invention, the aforementioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned information recording apparatus of the present invention, the computer program of the present invention can employ various aspects.

The above object of the present invention can be also achieved by a computer program product in a computer-readable medium for tangibly embodying a program of instructions executable by a computer provided in the aforementioned information recording apparatus of the present invention (including its various aspects), to make the computer function as the controlling device.

According to the computer program product of the present invention, the aforementioned information recording apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information recording apparatus of the present invention.

These effects and other advantages of the present invention will become more apparent from the following embodiments.

As explained above, on the information recording medium of the present invention, the phase of the wobbling of the recording track is opposite to that of the wobbling of the recording pit row. Therefore, it is possible to provide the good compatibility with the read-only type information recording medium. Moreover, according to the information recording apparatus of the present invention, it is provided with the recording device and the controlling device. According to the information recording method of the present invention, it is provided with the first controlling process and the second controlling process. Therefore, the information recording medium recorded by the information recording apparatus or method can be well compatible with the read-only type information recording medium.

### BRIEF DESCRIPTION OF DRAWINGS

FIG. 1 are a plan view and a cross sectional view showing an outline structure of an optical disc in an embodiment.

FIG. 2 is a partially enlarged perspective view showing a recording surface of the optical disc in the embodiment.

FIG. 3 is a block diagram conceptually showing the basic structure of an information recording/reproducing apparatus in an embodiment.

FIG. 4 is an enlarged perspective view showing a recording pit row formed on a groove track.

FIG. 5 are waveform charts conceptually showing the waveforms of push-pull signals, which are obtained by the reproduction of the optical disc on which the recording pit row is formed.

FIG. 6 are a plan view showing the recording pit row formed on a read-only type optical disc, and a waveform chart conceptually showing the waveform of the push-pull signal, which is obtained by the reproduction of the read-only type optical disc on which the recording pit row is formed.

FIG. 7 is a block diagram conceptually showing a more specific structure of the information recording/reproducing apparatus.

FIG. 8 is a plan view conceptually showing the recording pit row formed on the groove track.

FIG. 9 are waveform charts conceptually showing the waveforms of the push-pull signals which are obtained by the reproduction of the optical disc on which the recording pit row is formed.

### DESCRIPTION OF REFERENCE CODES

100 optical disc
119 wobble
200 information recording/reproducing apparatus
352 optical pickup
353 signal recording/reproducing device
501 LD
502 PD
505 objective lens
506 piezo element
512 phase delay circuit
513 gain circuit
GT groove track
LT land track

### BEST MODE FOR CARRYING OUT THE INVENTION

Hereinafter, the best mode for carrying out the present invention will be discussed in order for each embodiment, with reference to the drawings.

(Structure of Optical Disc)

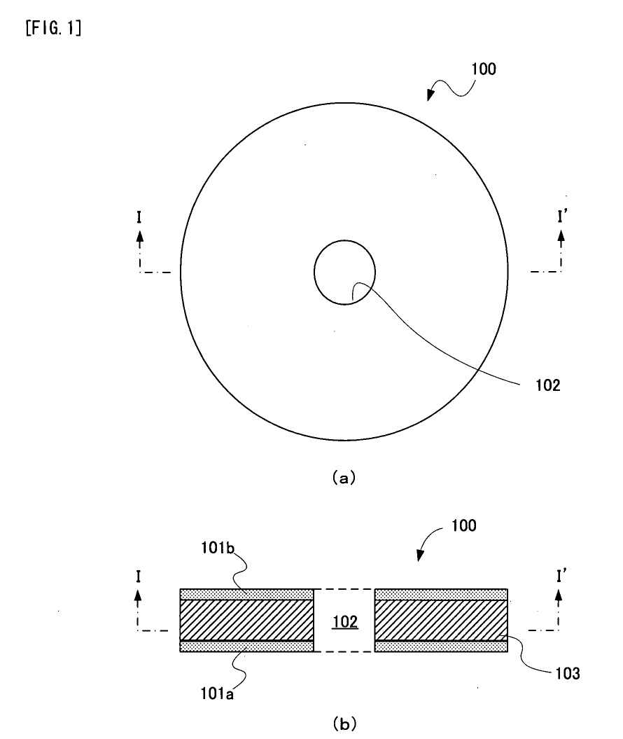

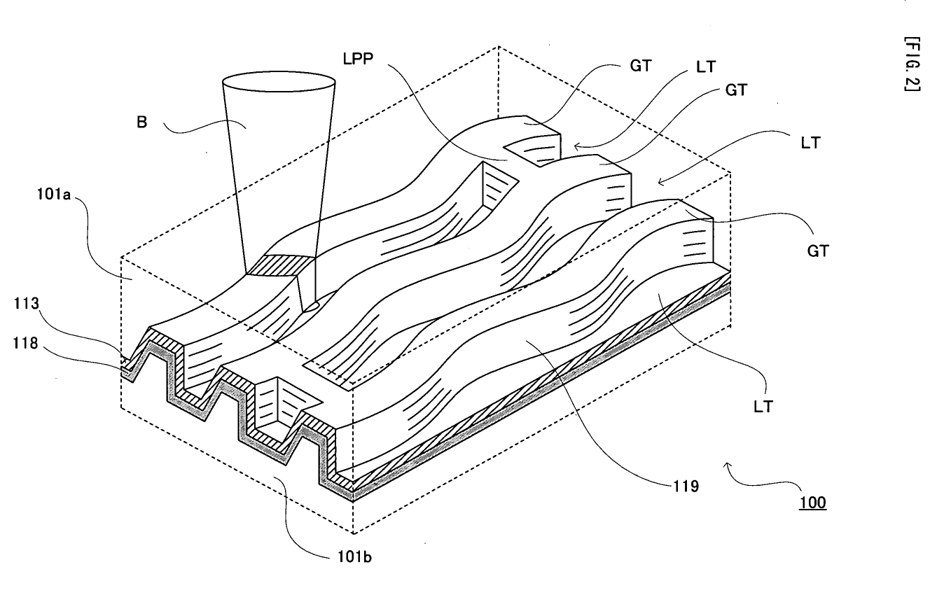

Firstly, the structure of an optical disc 100 as a recording medium in an embodiment will be explained by using FIG. 1. FIG. 1 are a plan view and a cross sectional view showing an outline structure of the optical disc 100. FIG. 2 is a partially enlarged perspective view showing a recording surface of the optical disc 100.

As shown in FIG. 1(a), the optical disc 100 is a circular disk shape with a diameter of about 12 cm, and it is provided with a center hole 102 in the center. As examples of the optical disc 100, there are listed a DVDR, a DVD±RW, a DVD-RAM, a BD (Blu-ray Disc), a HD DVD (High Definition DVD) and the like. As shown in FIG. 1(b), the optical disc 100 has such a structure that a recording layer 103 is disposed between transparent substrates 101a and 101b. Moreover, in each recording area in the recording layer 103, not-illustrated tracks, such as a groove track and a land track, are alternately displaced, spirally or concentrically, centered on the center hole 102. The data is divided and recorded by a unit of ECC block, on each or either one of the groove track and the land track.

The structure of the optical disc 100 will be more specifically explained. As shown in FIG. 2, on the optical disc 100, a recording film 113 of a phase change recording type or of an irreversible change recording type by heat or the like, which constitutes the recording surface for recording the data, is laminated on (or on the lower side in FIG. 2) the disc-shaped transparent substrate 101a, and a reflective film 118 is laminated thereon (or on the lower side in FIG. 2). Lastly, the transparent substrate 101b is laminated thereon. On the recording surface which is the surface of the recording film 113, a groove track GT and a land track LT, which constitute one specific example of the “recording track”, are alternately formed. Incidentally, upon the recording and the reproduction of the optical disc 100, as shown in FIG. 2, for example, the groove track GT is irradiated with laser light LB through the transparent substrate 101a. For example, upon the recording, by irradiating the laser light LB with a recording laser power, the phase change recording or the irreversible change recording by heat or the like is performed on the recording film 113, in accordance with the data to be recorded. On the other hand, upon the reproduction, by irradiating the laser light LB with a reproduction laser power, which is weaker than the recording laser power, the data recorded in the recording film 113 is read.

The groove track GT is oscillated (i.e. wobbled) with a certain amplitude and at a certain spatial frequency. The cycle of the wobble 119 is set to a predetermined value. On the land track LT, there is formed an address pit which is referred to as a land pre-pit LP and which indicates pre-format address information. By virtue of the two addressing (i.e. the wobble 119 and the land pre-pit LP), it is possible to obtain information necessary for disc rotation control during the recording, generation of a recording clock, or data recording, such as a recording address. Incidentally, it is also possible to record the pre-format address in advance, by modulating the wobble 119 of the groove track GT in a predetermined modulation method, such as frequency modulation and phase modulation.

(Information Recording/Reproducing Apparatus)

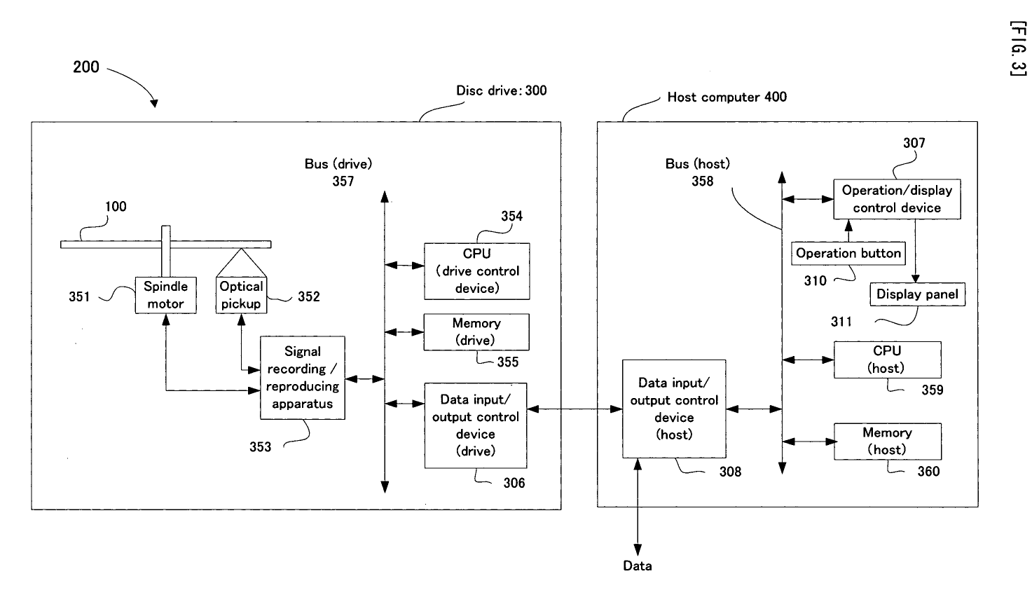

Next, with reference to FIG. 3 to FIG. 9, an explanation will be given on the structure and the operation of an information recording/reproducing apparatus as an embodiment of the information recording apparatus of the present invention.

(1) Basic Structure

Firstly, with reference to FIG. 3, the basic structure of an information recording/reproducing apparatus 200 in an embodiment of the information recording apparatus of the present invention will be discussed. FIG. 3 is a block diagram showing the basic structure of the information recording/reproducing apparatus 200 in the embodiment. Incidentally, the information recording/reproducing apparatus 200 has a function of recording data onto the optical disc 100 and a function of reproducing the data recorded on the optical disc 100.

As shown in FIG. 3, an information recording/reproducing apparatus 200 is provided with: a disc drive 300; and a host computer 400, wherein on the disc drive 300, the optical disc 100 is actually loaded and on which the data is recorded or reproduced, and on the host computer 400, such has a personal computer, the data recording and reproduction with respect to the disc drive 300 are controlled.

The disc drive 300 is provided with: the optical disc 100 or the like; a spindle motor 351; an optical pickup 352; a signal recording/reproducing device 353; a CPU (drive control device) 354; a memory 355; a data input/output control device 306 and a bus 357. Moreover, the host computer 400 is provided with: a CPU 359; a memory 360; an operation/display control device 307; an operation button 310; a display panel 311; and a data input/output control device 308.

The spindle motor 351 is intended to rotate and stop the optical disc 100 or the like, and operates upon accessing the optical disc 100 or the like. More specifically, the spindle motor 351 is adapted to rotate the optical disc 100 or the like at a predetermined speed and stop it, under spindle servo from a not-illustrated servo unit or the like.

The optical pickup 352 constitutes one specific example of the “recording device” of the present invention and is provided with a semiconductor laser device, a lens, and the like, to record or reproduce the data with respect to the optical disc 100 or the like. More specifically, the optical pickup 352 irradiates the optical disc 100 or the like with a light beam, such as a laser beam, as reading light with a first power upon reproduction, and as writing light with a second power upon recording, with it modulated. This causes recording pits to be formed on e.g. the groove track GT.

The signal recording/reproducing device 353 constitutes one specific example of the “controlling device” of the present invention, and it controls the spindle motor 351 and the optical pickup 352, to thereby perform the recording/reproduction on the optical disc 100 or the like. More specifically, the signal recording/reproducing device 353 is provided with: a laser diode (LD) driver; a head amplifier; and the like, for example. The laser diode driver (LD driver) drives a not-illustrated semiconductor laser device located in the optical pickup 352. The head amplifier amplifies the output signal of the optical pickup 352, i.e. the reflective light of a light beam, and outputs the amplified signal.

The memory 355 is used in the general data processing and an OPC process or the like on the disc drive 300, including an area which is used as an buffer area for recording/reproducing the data and an intermediate buffer when the data is converted to the data that can be used on the signal recording/reproducing device 353, and the like. Moreover, the memory 355 is provided with: a ROM area into which a program (i.e. firmware) for performing an operation as a recording device is stored; a buffer for temporary storage of the record/reproduction data; a RAM area into which a parameter required for the operation of a firmware program or the like is stored; and the like.

The CPU (drive control device) 354 is connected to the signal recording/reproducing device 353 and the memory 355 through the bus 357, and controls the entire disc drive 300 by giving an instruction to various controlling devices. Normally, software or firmware for operating the CPU 354 is stored in the memory 355.

The data input/output control device 306 controls the input/output of the data from the exterior with respect to the disc drive 300, to thereby perform storage to and export from the data buffer on the memory 355. A drive control command, issued from the external host computer 400 connected to the disc drive 300 through an interface, such as a SCSI and an ATAPI, is transmitted to the CPU 354 through the data input/output control device 306. Moreover, the record/reproduction data is also exchanged with the host computer 400 through the data input/output control device 306, in the same manner.

The operation/display control device 307 receives an operation instruction and performs display with respect to the host computer 400, and transmits an instruction by the operation button 310, such as an instruction to record or reproduce, to the CPU 359. The CPU 359 may transmit a control command to the disc drive 300, through the data input/output control device 308, on the basis of instruction information from the operation/display control device 307, to thereby control the entire disc drive 300. In the same manner, the CPU 359 can transmit a command for requesting the disc drive 300 to transmit an operational state to the host, with respect to the disc drive 300. By this, the operational state of the disc drive 300, such as during recording and during reproduction, can be recognized, so that the CPU 359 can output the operational state of the disc drive 300 to the display panel 310, such as a fluorescent tube and an LCD, through the operation/display control device 307.

The memory 360 is an inner storage apparatus used by the host computer 400, and is provided with: a ROM area into which a firmware program, such as a BIOS (Basic Input/Output System), is stored; a RAM area into which a parameter required for the operation of an operating system and an application program or the like is stored; and the like. Moreover, the memory 360 may be connected to a not-illustrated external storage apparatus, such as a hard disk, through the data input/output control device 308.

One specific example used by combining the disc drive 300 and the host computer 400, as explained above, is household equipment, such as recorder equipment for recording and reproducing video images. The recorder equipment records a video signal from a broadcast reception tuner and an external connection terminal, onto a disc, and outputs the video signal reproduced from the disc to external display equipment, such as a television. The operation as the recorder equipment is performed by executing a program stored in the memory 360, on the CPU 359. Moreover, in another specific example, the disc drive 300 is a disc drive (hereinafter referred to as a “drive”, as occasion demands), and the host computer 400 is a personal computer and a work station. The host computer, such as the personal computer, and the drive are connected through the data input/output control devices 306 and 308, such as the SCSI and the ATAPI, and application, such as writing software, installed in the host computer 400 controls the disc drive 300.

(2) Operation Principle

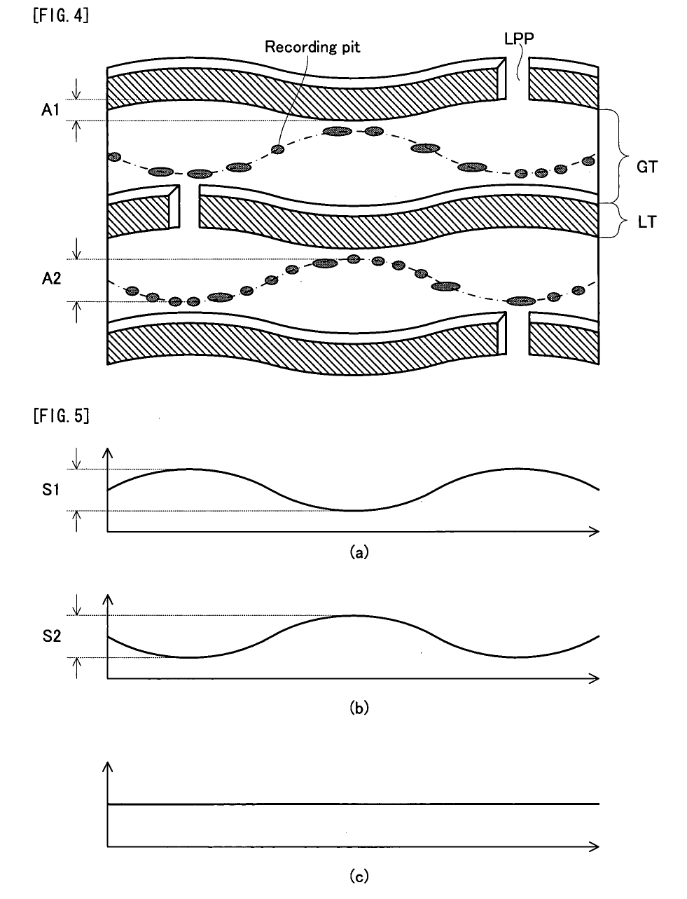

Next, with reference to FIG. 4 and FIG. 5, the recording pit row formed by the recording/reproducing apparatus 200 in the embodiment will be discussed. FIG. 4 is an enlarged perspective view showing the recording pit row formed on the groove track GT. FIG. 5 are waveform charts conceptually showing the waveforms of push-pull signals, which are obtained by the reproduction of the optical disc 100 on which the recording pit row is formed.

As shown in FIG. 4, the recording/reproducing apparatus 200 in the embodiment forms the recording pit row (i.e. row of assembled recording pits), which is wobbled in an opposite phase to a phase of the wobbling of the groove track GT (or the phase of the wobble 119). In order to make the aspect of the wobbling of the recording pit row understandable, the aspect of the wobbling of the recording pit row is shown in an alternate long and short line in FIG. 4. Specifically, in FIG. 4, the recording pit row which swings relatively upwardly, as observed from the entire recording pit row, is formed on a portion of the groove track GT which swings relatively downwardly. On the other hand, in FIG. 4, the recording pit row which swings relatively downwardly, as observed from the entire recording pit row, is formed on a portion of the groove track GT which swings relatively upwardly. In particular, the groove track GT is wobbled at a fixed frequency. Thus, the phase of the wobbling of the groove track GT and the phase of the wobbling of the recording pit row are shifted by a half cycle. Moreover, an amplitude A2 of the wobbling of the recording pit row is about twice as large as an amplitude A1 of the wobbling of the groove track GT.

If the optical disc 100 on which such a recording pit row is formed is reproduced, the signal components of a push-pull signal, as shown in FIG. 5(a) and FIG. 5(b), are obtained. Specifically, FIG. 5(a) shows the signal component of the push-pull signal, which is obtained by irradiating the groove track GT with the laser light LB (hereinafter referred to as a “signal component caused by the groove track GT”, as occasion demands). In the same manner, FIG. 5(b) shows the signal component of the push-pull signal, which is obtained by irradiating the recording pit row with the laser light LB (hereinafter referred to as a “signal component caused by the recording pit row”, as occasion demands). Since the phase of the wobbling of the groove track GT and the phase of the wobbling of the recording pit row are opposite to each other, the signal component caused by the groove track GT and the signal component caused by the recording pit row are oscillated in phases which are opposite to each other, respectively.

Moreover, the general recording pit row is formed such that a ratio of a mark portion in which the recording pits are formed and a space portion in which the recording pits are not formed becomes about 1:1 (i.e. a duty ratio is about 50%). Moreover, since the amplitude A2 of the wobbling of the recording pit row is about twice as large as the amplitude A1 of the wobbling of the groove track GT, an amplitude S2 of the signal component caused by the recording pit row is substantially the same as an amplitude S1 of the signal component caused by the groove track GT.

Thus, the push-pull signal which is actually obtained by the information recording/reproducing apparatus 200 in the reproduction operation (i.e. a sum signal of the signal component caused by the groove track GT and the signal component caused by the recording pit row) is a signal including only a direct current component, as shown in FIG. 5(c).

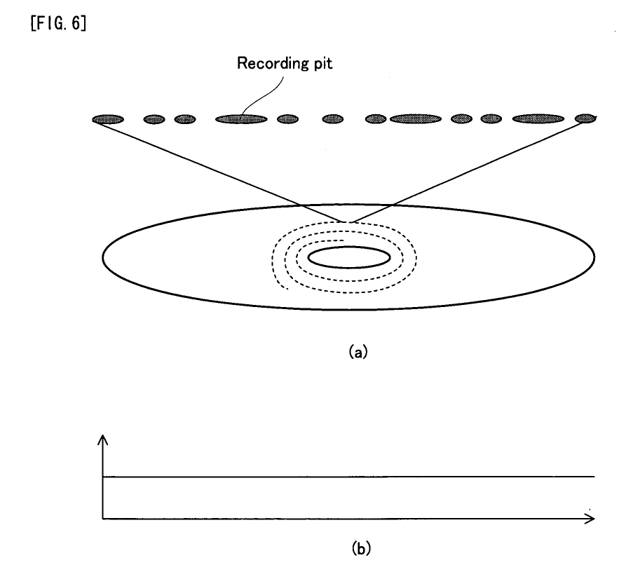

Now, with reference to FIG. 6, an explanation is given on the recording pits and the push-pull signal in the read-only type optical disc (e.g. a CD-ROM, a DVD-ROM, or the like). FIG. 6 are a plan view showing the recording pit row formed on the read-only type optical disc, and a waveform chart conceptually showing the waveform of the push-pull signal, which is obtained by the reproduction of the read-only type optical disc on which the recording pit row is formed.

As shown in FIG. 6(a), on the read-only type optical disc, the recording pits are formed by using depressions (or holes) on the recording surface. The recording pits are formed to be distributed spirally on the optical disc; however, the recording pits are not wobbled. Thus, the recording pits are regarded as to be formed while distributing linearly, seen from the recording/reproducing apparatus 200. At this time, the read-only type optical disc does not have the groove track GT and the land track LT, which are provided for the recording type optical disc 100. Thus, the push-pull signal which is obtained by the reproduction of the read-only type optical disc is a signal including only a direct current component, as shown in FIG. 6(b).

As described above, if the optical disc 100 on which the recording pit row is formed by the information recording/reproducing apparatus 200 in the embodiment is reproduced, it is possible to obtain the push-pull signal which is the same or substantially the same as the push-pull signal which is obtained by the reproduction of the read-only type optical disc. Thus, even in the case of a read-only type information reproducing apparatus for the reproduction of the read-only type optical disc, it is possible to preferably reproduce the recording pit row formed by the information recording/reproducing apparatus 200 in the embodiment, without any special problem. If the recording pit row that is not wobbled is formed on the groove track GT, the push-pull signal has a waveform corresponding to the wobbling of the groove track GT. This possibly influences the reproduction operation because this is not same as the push-pull signal which is originally expected for the read-only type information reproducing apparatus. However, according to the embodiment, since the same push-pull signal (or reproduction signal) is obtained from both the read-only type optical disc and the recording type optical disc in the embodiment, it is possible to maintain the preferable reproduction operation particularly on the read-only type information reproducing apparatus. In conclusion, the recording type optical disc 100 on which the recording pit row is formed by the information recording/reproducing apparatus 200 in the embodiment can be preferably compatible with the read-only type optical disc.

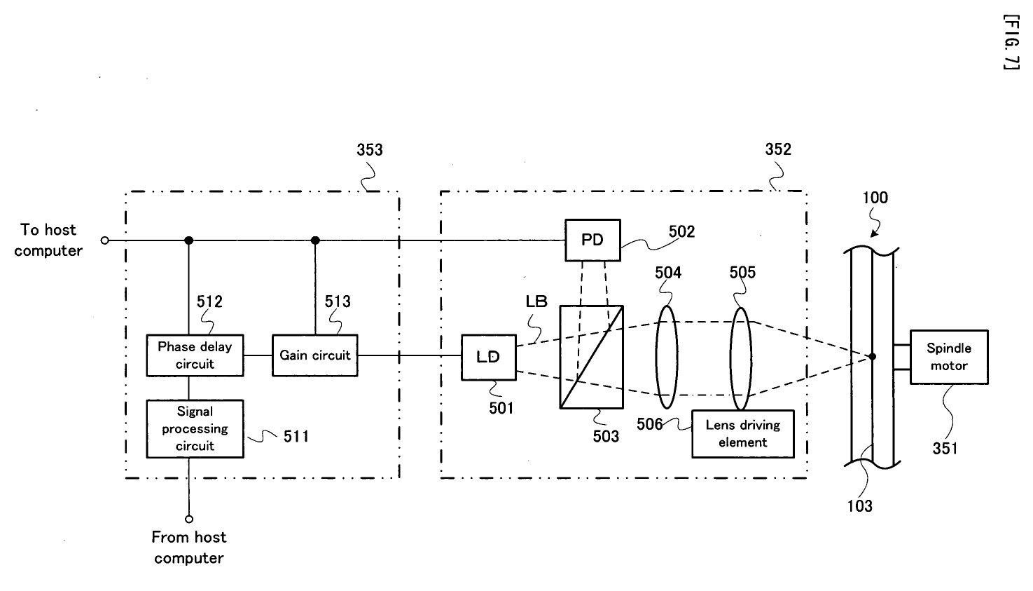

With reference to FIG. 7, an explanation will be given on a more specific structure of the information recording/reproducing apparatus 200 to form such a recording pit row. FIG. 7 is a block diagram conceptually showing the more specific structure of the information recording/reproducing apparatus 200.

As shown in FIG. 7, the optical pickup 352 is provided with: a LD (Laser Diode) 501; a PD (Photo Detector) 502; a beam splitter 503; a collecting lens 504; an objective lens 505; and a lens driving element 506.

The LD 501 constitutes one specific example of the “irradiating device” of the present invention, and it irradiates the laser light LB to the optical disc 100.

The PD 502 constitutes one specific example of the “detecting device” of the present invention, and it receives the reflected light of the laser light LB which is irradiated from the LD 501. A light receiving signal is generated from the received reflected light, is outputted to the host computer 400, and is reproduced as the reproduction data. Moreover, the light receiving signal is outputted to a phase delay circuit 512 and a gain circuit 513, which are provided for the signal recording/reproducing device 353, and is referred to when a record signal is generated.

The beam splitter 503 passes the laser light LB which is outputted from the LD 501, and it refracts or reflects the reflected light of the laser light LB which enters from a surface which is opposite to the incident surface of the laser light LB, to thereby focus the light on the PD 502.

The collecting lens 504 makes the incident laser light LB substantially parallel and makes it enter the objective lens 505.

The objective lens 505 is entered by the laser light LB which is made substantially parallel by the collecting lens 504. The objective lens 505 focuses the laser light LB and irradiates it on the optical disc 100.

The lens driving element 506 has a driving mechanism for changing the disposed position of the objective lens 505. The lens driving circuit 506 includes a piezo element which is driven in accordance with a driving signal, supplied from a not-illustrated tracking driving circuit. The lens driving circuit 506 displaces the position of the objective lens 505 in a tracking direction or in a focus direction.

Since the lens driving element 506 includes the piezo element, which has high-speed responsiveness, it is possible to form the recording pit row which is wobbled in the opposite phase to the phase of the wobbling of the groove track GT which is wobbled at relatively high speed (i.e. which is wobbled at high frequency).

Moreover, the signal recording/reproducing device 353 is provided with: a signal processing circuit 511; a phase delay circuit 512; and a gain circuit 513.

The signal processing circuit 511 appends a correction code for error correction or gives predetermined modulation to the data for recording, which is supplied from the host computer 400, to thereby generate the record signal.

The phase delay circuit 512 constitutes one specific example of the “delay giving circuit” of the present invention, and it performs a phase delay on the record signal which is outputted from the signal processing circuit 511. Specifically, the phase delay circuit 512 detects the timing or phase of the wobbling of the groove track GT from the light receiving signal, which is generated on the PD 502, and it performs the phase delay on the record signal so as to form the recording pit row which is wobbled in the opposite phase to the phase of the wobbling of the groove track GT. In particular, since the groove track GT of the optical disc 100 is wobbled in the fixed cycle, the phase delay circuit 512 performs the phase delay on the record signal so as to form the recording pit row which is wobbled in the phase that is shifted by a half cycle with respect to the phase of the wobbling of the groove track GT.

The gain circuit 513 constitutes one specific example of the “gain adjusting device” of the present invention, and it adjusts the gain of the record signal, which is outputted from the signal processing circuit 511. Specifically, the gain circuit 513 detects the amplitude of the wobbling of the groove track GT from the light receiving signal, which is generated on the PD 502, and it adjusts the gain of the record signal so as to form the recording pit row which has an amplitude substantially twice as large as the amplitude of the wobbling of the groove track GT.

By providing such construction for the information recording/reproducing apparatus 200, it is possible to preferably form the recording pit row which is wobbled in the opposite phase to the phase of the wobbling of the groove track GT and which has an amplitude substantially twice as large as the amplitude of the wobbling of the groove track GT, as described above.

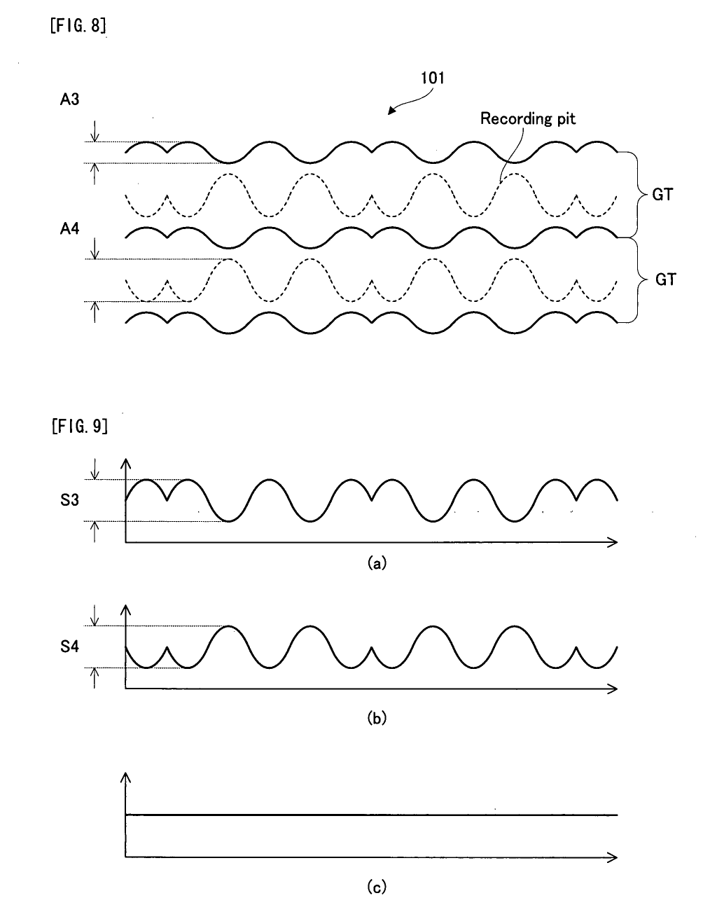

Incidentally, in the aforementioned explanation, the optical disc 100 on which the groove track GT is wobbled in the fixed cycle, such as a DVD-R/RW, is used for explanation. However, the same can be true not only for the optical disc 100 on which the groove track GT is wobbled in the fixed cycle but also for an optical disc 101 (e.g. a DVD+R/RW or the like) provided with the groove track GT on which BPM modulation is performed to wobble, as shown in FIG. 8 and FIG. 9. FIG. 8 is a plan view conceptually showing the recording pit row formed on the groove track GT. FIG. 9 are waveform charts conceptually showing the waveforms of the push-pull signals which are obtained by the reproduction of the optical disc 100 on which the recording pit row is formed. Incidentally, in FIG. 8, the land track LT is omitted for simplification of explanation.

As shown in FIG. 8, BPM (Bi Phase Modulation) modulation is performed on the groove track GT of the optical disc 101. Even in this case, the information recording/reproducing apparatus 200 in the embodiment forms the recording pit row which is wobbled in the opposite phase to the phase of the wobbling of the groove track GT. Moreover, an amplitude A4 of the wobbling of the recording pit row is about twice as large as an amplitude A3 of the wobbling of the groove track GT.

In the case of the reproduction of the optical disc 100 on which such a recording pit row is formed, a signal component caused by the groove track GT shown in FIG. 9(a) and a signal component caused by the recording pit row shown in FIG. 9(b) are obtained. Since the phase of the wobbling of the groove track GT and the phase of the wobbling of the recording pit row are opposite to each other, the signal component caused by the groove track GT and the signal component caused by the recording pit row are wobbled in phases which are opposite to each other. Moreover, since the amplitude A4 of the wobbling of the recording pit row is about twice as large as the amplitude A3 of the wobbling of the groove track GT, an amplitude S4 of the signal component caused by the recording pit row is substantially the same as an amplitude S3 of the signal component caused by the groove track GT.

Thus, the push-pull signal which is actually obtained by the information recording/reproducing apparatus 200 in the reproduction operation (i.e. a sum signal of the signal component caused by the groove track GT and the signal component caused by the recording pit row) is a signal including only a direct current component, as shown in FIG. 9(c). Therefore, even in the optical disc 101, it is possible to receive the aforementioned various benefits.

Incidentally, regardless of the aspect of the wobbling of the groove track GT, it is obvious that the aforementioned various benefits can be received if there is formed the recording pit row which is wobbled in the opposite phase to the phase of the wobbling of the groove track GT and which has an amplitude substantially twice as large as the amplitude of the wobbling of the groove track GT, as described above.

Moreover, in the aforementioned embodiments, the optical disc 100 or the like is explained as one example of the information recording medium, and the recorder related to the optical disc 100 or the like is explained as one example of the information recording apparatus. The present invention, however, is not limited to the optical disc and the recorder thereof, and can be applied to other various recording media, and the recorders thereof, which support high density recording or high transfer rate.

The present invention is not limited to the aforementioned embodiments, and various changes may be made, if desired, without departing from the essence or spirit of the invention which can be read from the claims and the entire specification. An information recording medium, an information recording apparatus and method, and a computer program for recording control, which involve such changes, are also intended to be within the technical scope of the present invention.

### INDUSTRIAL APPLICABILITY

The information recording medium, the information recording apparatus and method, and the computer program according to the present invention can be applied to a DVD recorder, and an information recording apparatus, such as a DVD recorder. Moreover, they can be applied to an information recording apparatus or the like, which is mounted on or can be connected to various computer equipment for consumer use or business use, for example.

1. An information recording medium comprising: a recording track, which is wobbled, on which information is recorded by forming a recording pit row thereon,
the recording pit row being formed to be wobbled in an opposite phase to a phase of the wobbling of the recording track.

2. The information recording medium according to claim 1, wherein an amplitude of the wobbling of the recording pit row is substantially twice as large as an amplitude of the wobbling of the recording track.

3. The information recording medium according to claim 1, wherein a duty ratio of the recording pit row is about 50%.

4. The information recording medium according to claim 1, wherein the recording track is modulated and wobbled.

5. An information recording apparatus comprising:
a recording device for recording information by forming a recording pit row on a recording track which is wobbled; and
a controlling device for controlling said recording device to form the recording pit row which is wobbled in an opposite phase to a phase of the wobbling of the recording track.

6. The information recording apparatus according to claim 5, wherein said controlling device controls said recording device to form the recording pit row whose amplitude of the wobbling is substantially twice as large as an amplitude of the wobbling of the recording track.

7. The information recording apparatus according to claim 5, wherein said controlling device controls said recording device to form the recording pit whose duty ratio is about 50%.

8. The information recording apparatus according to claim 5, wherein the recording track is modulated and wobbled.

9. The information recording apparatus according to claim 5, further comprising a speed reducing device for reducing a recording speed of the information, compared to a case where the recording pit row which is wobbled in the same phase as the phase of the wobbling of the recording track is formed.

10. The information recording apparatus according to claim 5, further comprising:
a detecting device for detecting at least one of the phase and an amplitude of the wobbling of the recording track;
a delay giving device for giving a phase delay to a record signal in order to form the recording pit row, on the basis of the detected phase of the wobbling; and
a gain adjusting device for adjusting gain of the record signal on the basis of the detected amplitude of the wobbling.

11. The information recording apparatus according to claim 5, wherein said recording device includes: an irradiating device for irradiating laser light to thereby form the recording pit row; and an optical path adjusting device for adjusting an optical path of the laser light.

12. The information recording apparatus according to claim 11, wherein the optical path adjusting device comprises a piezo element.

13. An information recording method on an information recording apparatus comprising: a recording device for recording information by forming a recording pit row on a recording track which is wobbled, said information recording method comprising:
a first controlling process of controlling said recording device to form the recording pit row corresponding to the information; and
a second controlling process of controlling said recording device to form the recording pit row which is wobbled in an opposite phase to a phase of the wobbling of the recording track.

14. A computer program product in a computer-readable medium for tangibly embodying a program of instructions executable by a computer provided in an information recording apparatus comprising: a recording device for recording information by forming a recording pit row on a recording track which is wobbled; and a controlling device for controlling said recording device to form the recording pit row which is wobbled in an opposite phase to a phase of the wobbling of the recording track,
said computer program making the computer function as said controlling device.
